(19) United States
(12) Patent Application Publication
(10) Pub. No.: US 2014/0130595 A1
(43) Pub. Date: May 15, 2014

(54) MONOLITHIC SENSOR PACKAGE

(71) Applicant: MEMSIC, INC., Andover, MA (US)

(72) Inventors: Yang Zhao, Andover, MA (US); Paul M. Zavracky, Boston, MA (US); Yongyao Cai, Acton, MA (US)

(73) Assignee: MEMSIC, INC., Andover, MA (US)

(21) Appl. No.: 13/674,506

(22) Filed: Nov. 12, 2012

(51) Int. Cl. G01D 5/54

(52) U.S. Cl. CPC G01D 5/54
USPC 73/495

(57) ABSTRACT

A unitary sensor package having a magnetometer, accelerometer and gyroscope incorporated into a monolithic structure composed of one or more wafers or substrates. Pressure and/or other types of sensors can also be incorporated in the monolithic structure.

### STATEMENT REGARDING FEDERALLY SPONSORED RESEARCH OR DEVELOPMENT

N/A

### BACKGROUND OF THE INVENTION

Portable electronic devices such as smart phones, computer tablets and digital cameras often employ sensors for determining the orientation of the device and the location of the device. Two or three axis accelerometers are widely employed for determining orientation, tilt and movement of a device. Single or multi-axis gyroscopes (gyros) are often employed for determining orientation and movement of a device. Magnetic sensors are often employed for determining compass heading and other compass applications. Accelerometers, gyros and magnetic sensors are in conventional practice individually packaged, therefore three different sensor packages must be included in a portable device if the functionality provided by all three sensors is desired. The market trend has been for portable electronic devices to become smaller and smaller but the space requirements of multiple sensor packages limits the size of the device in which these sensors can be housed.

It would be desirable to provide multiple sensor types in a single small unitary package to minimize the space requirements needed in a device in which the sensor package is installed.

### BRIEF SUMMARY OF THE INVENTION

The invention comprises a monolithic structure composed of at least one substrate or wafer containing a magnetic sensor, an accelerometer sensor and a gyroscope sensor. Other types of sensors can be incorporated into the monolithic structure as well such as pressure, acoustic, chemical and humidity sensors. The magnetometer, accelerometer and gyroscope can alternatively be of single or dual axis, as well a three axis devices.

In one aspect, a unitary 9° of freedom sensor package has a three axis magnetometer, three axis accelerometer and three axis gyroscope incorporated into a single package having a small form factor and which can be fabricated in large volume production at low cost.

In one embodiment of the invention, three wafers or substrates are stacked together and bonded or joined using wafer bonding and through-silicon via (TSV) techniques to form a unitary or monolithic structure. One wafer contains a three axis MEMS accelerometer and three axis MEMS gyroscope which preferably are integrated in the wafer with associated circuitry. A second wafer having a cavity over the MEMS structure is sealed at one surface to the first wafer and is sealed at its opposite surface to a third wafer having a magnetic sensor. The unitary multi wafer package is connectable to a circuit board or other mounting surface by connection elements such as solder balls. The connection elements may be on the outer surface of the third wafer or on the outer surface of the first wafer in alternative embodiments.

In another embodiment the magnetic sensor is disposed on one or more side walls of the cavity in the second wafer to provide a structure having only first and second wafers or substrates rather than the three substrate embodiment described above. Alternatively, the magnetic sensor can be mounted or formed on the top of the second wafer.

In a further embodiment, a first substrate contains the MEMS structure, and a second substrate has a cavity capped over the MEMS structure as in the embodiment described above, but with the magnetic sensor substrate mounted on the outer surface of the first substrate between the connection elements.

The invention can also be embodied in a single wafer or single substrate unitary structure. In one implementation, an accelerometer and gyroscope structure is micro machined in one surface of the wafer which also contains an ASIC or other integrated circuit associated with the sensors. Pressure and/or other types of sensors can also be formed in the wafer. A magnetic sensor is provided on the opposite surface of the wafer. Interconnections between the top and bottom of the wafer can be by through silicon vias or chip edge interconnections or other interconnection forms. A single wafer or chip can be packaged in any of the standard electronic package forms including LCC or overmolding.

The invention is not limited to three axis sensors but can also be implemented with single axis, and/or two axis sensors as may be suitable for particular uses and applications.

As noted above, in addition to orientation sensors, other sensors can be incorporated into the unitary structure in accordance with the invention. Such additional sensors include pressure, acoustic, chemical and humidity sensors as examples. The pressure sensor can be typically of the piezoresistive or capacitive type. The other types of sensors can be of various forms which per se are known.

The sensors may be formed in the wafers of the package by MEMS and integrated circuit techniques or the sensors may be formed in one or more wafers which are separate from the package substrates and to which the sensor wafers are mounted.

### BRIEF DESCRIPTION OF THE SEVERAL VIEWS OF THE DRAWINGS

The invention will be more fully described in the following detailed description in conjunction with the drawings in which:

FIG. 1 is a diagrammatic elevation view of one embodiment of a sensor package in accordance with the invention;

FIG. 2 is a diagrammatic elevation view of a second embodiment of a sensor package in accordance with the invention;

FIG. 2A is a diagrammatic elevation view of an alternative embodiment in accordance with the invention;

FIG. 3 is a diagrammatic elevation view of a third embodiment of a sensor package in accordance with the invention using two substrates;

FIG. 4 is a diagrammatic elevation view of another embodiment of the invention using two substrates; and

FIG. 5 is a diagrammatic elevation view of a further embodiment of the invention in which the magnetic sensor is mounted to the first substrate;

FIG. 5A is a diagrammatic elevation view of an alternative embodiment in accordance with the invention;

FIG. 6 is a diagrammatic elevation view of a single wafer embodiment in accordance with the invention; and

FIG. 7 is a diagrammatic elevation view of another single wafer embodiment in accordance with the invention.

### DETAILED DESCRIPTION OF THE INVENTION

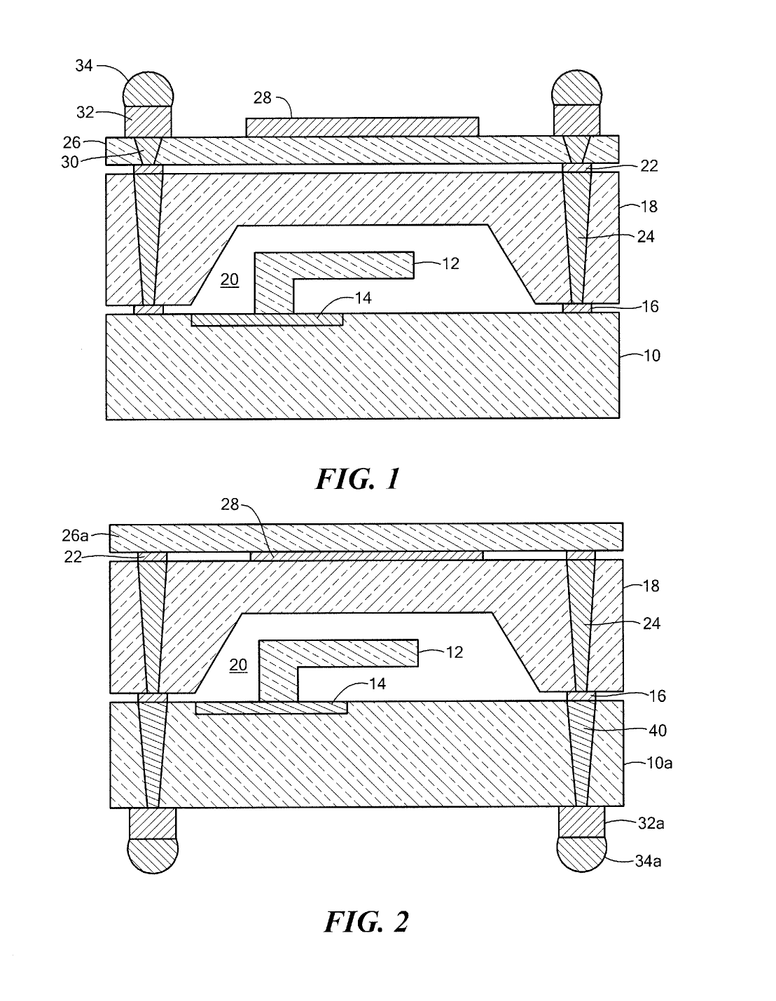

Referring to FIG. 1, there is shown a first wafer or substrate 10 which typically is a CMOS wafer which has a MEMS structure 12 configured to form, in one embodiment, a three axis accelerometer and three axis gyroscope, and circuitry 14, typically an ASIC, that is coupled to the accelerometer and gyroscope structure through conductive traces in the wafer by techniques known to those of ordinary skill in the art. A plurality of conductive pads 16 are provided on the upper surface of the first wafer 10 and are coupled to the circuitry 14 and the accelerometer and gyroscope sensors 12. The MEMS accelerometer and gyroscope structure is shown diagrammatically; the actual structure of such devices is known to those of ordinary skill in the art. Likewise the circuitry 14 is shown diagrammatically as a block and the structure of such circuitry is also known to those of ordinary skill in the art.

A second wafer or substrate 18 is provided on the first wafer 10 and is sealed thereto around the periphery of the mated wafers 10 and 18. The second wafer 18 has a cavity 20 therein which encloses the MEMS structure. The wafers 10 and 18 can be sealed by use of a sealing ring provided about the periphery of the wafers at the areas to be sealed. Many known types of sealing or bonding may be used for example eutectic, thermo-compression or epoxy bonding.

When the accelerometer is of the thermal type, a gas may be sealed in the cavity 10. Preferably the gas is a heavy gas having a large molecular weight such as for example, SF6, HFC125, HFC227 and C3F8 as examples. The pressure of the gas is typically in the range of about 0.5 to 4.0 atmospheres. Bonding machines that also insert gas are known to those of ordinary skill in the art to provide the gas within the cavity during the sealing or bonding operation. Pads 22 are provided on the upper surface of wafer 18 and are interconnected to pads 16 by through-silicon vias (TSV) 24. The vias are formed by known techniques such as deep reactive ion etching (DRIE).

A third wafer or substrate 26 is provided over wafer 18 and in which or on which a magnetic sensor 28 or other orientation sensitive sensor is provided. The magnetic sensor can be protected by encapsulation or by an overcoat for example. Vias 30 are provided through the wafer 26 to interconnect pads 22 and vias 24 to connection elements which in the illustrated embodiment include pillars 32 and solder balls 34 provided on the outer surface of wafer 26. The pillars 32 provide clearance for the magnetic sensor 28 and are not needed in all embodiments. The solder balls 34 are typically in a BGA configuration for mounting to an associated circuit board or other mounting surface. The connection elements can be of many different forms to suit particular mounting requirements and the solder ball connections are to be considered as illustrative or exemplary and not limiting.

The multi wafer structure of FIG. 1 is of flip chip configuration in which during mounting the package is oriented with the solder balls 34 on the bottom of the package and which are reflow soldered or otherwise joined to the contact pads of an underlying printed circuit board.

The wafer 10 is preferably a silicon wafer in which the MEMS accelerometer and gyroscope structure and the ASIC or other circuitry is formed preferably by CMOS processing. The second wafer 18 may be of glass, silicon or other appropriate material but need not be a semiconductor material as this second wafer 18 is used for structural purposes and not for incorporating any integrated circuitry or MEMS structures. It is recognized that if two different materials are used for wafers 10 and 18 the respective coefficient of thermal expansion (CTE) of the two materials should not differ too much in order to avoid any warpage or stress of the device after the wafers are bonded together.

The magnetic sensor 28 may be a separate silicon chip or wafer with contact pads provided thereon for connection via traces on wafer 16 to the vias 30 and subsequent circuitry. Alternatively, the magnetic sensor can be integrated into a silicon wafer 26 and connected by appropriate traces on wafer 26 to the vias 30.

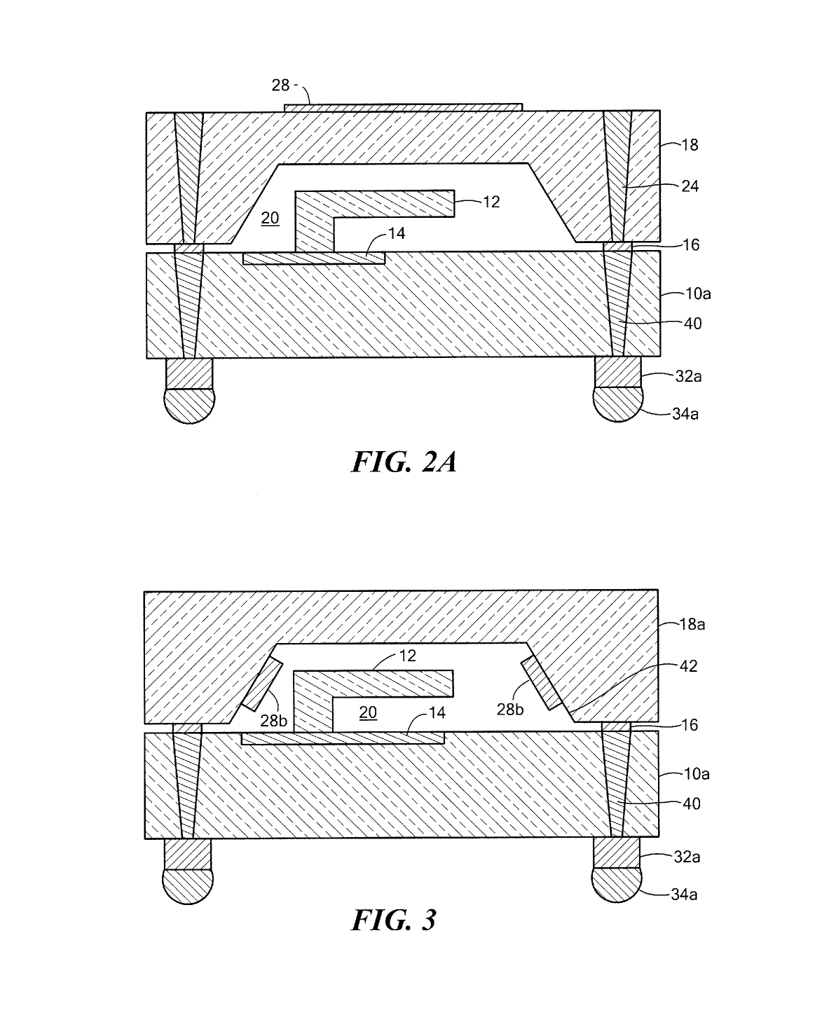

An alternative embodiment is shown in FIG. 2 in which the solder balls or other connection elements are at the bottom surface of wafer 10a. Vias 40 are provided in wafer 10a to connect the pillars 32a and pads 16 on the top surface of wafer 10a. The vias 24 connect pads 16 and pads 22 as in the embodiment of FIG. 1. In this embodiment of FIG. 2, the magnetic sensor 28a is on the bottom of wafer 26a. The magnetic sensor and its wafer or substrate 26a can be flip chip bonded to pads 22 without need for vias as are used in the FIG. 1 embodiment.

An alternative implementation is shown in FIG. 2A which is similar to that of FIG. 2, but in which the magnetic sensor 28 is on the top of wafer 18 and wafer 26 is eliminated. The sensor 28 is connected to selected ones of the vias 24 by traces on wafer 18. The magnetic sensor 28 can be covered such as with an encapsulant or overcoat.

An embodiment is shown in FIG. 3 in which only two wafers or substrates are employed. The wafer 10a is configured in the same manner as in FIG. 2. Vias 40 through wafer 10a connect pillars 32a on the bottom surface of the wafer to pads 16 on the top surface of the wafer. The wafer 18a has magnetic sensors 28b provided on one or more the slopped surfaces 42 of cavity 20 of wafer 18a. The mounting of a magnetic sensor on a sloped surface permits measurement along two orthogonal axes by a single axis sensor, as is known. In this embodiment, vias are needed only through wafer 10a. There is no need for vias through wafer 18a as in the embodiments of FIG. 1 and FIG. 2. The embodiment of FIG. 3 can be less expensive to fabricate as vias are needed in only one wafer rather than in two wafers as in the above-described embodiments. In an alternative version of the embodiment of FIG. 3, vias are provided through wafer 18a rather than through wafer 10a. The vias through wafer 18a interconnect pads 16 with pillars 32a and solder balls 34a which would be on the top surface of wafer 18a.

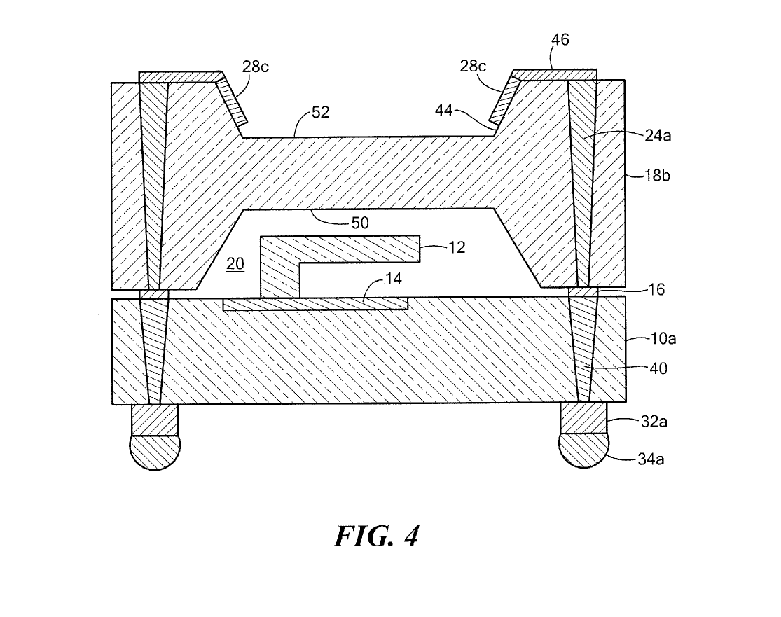

A further embodiment is shown in FIG. 4. The upper wafer 18b has two cavities or trenches. The lower cavity 50 defines chamber 20, and the upper cavity 52 has slopping sides 44 on which magnetic sensors 28c are disposed. The sensors are connected to upper pads 46 which are also connected to vias 24a. The top surface including the magnetic sensors can be protected such as by encapsulation or by an overcoat.

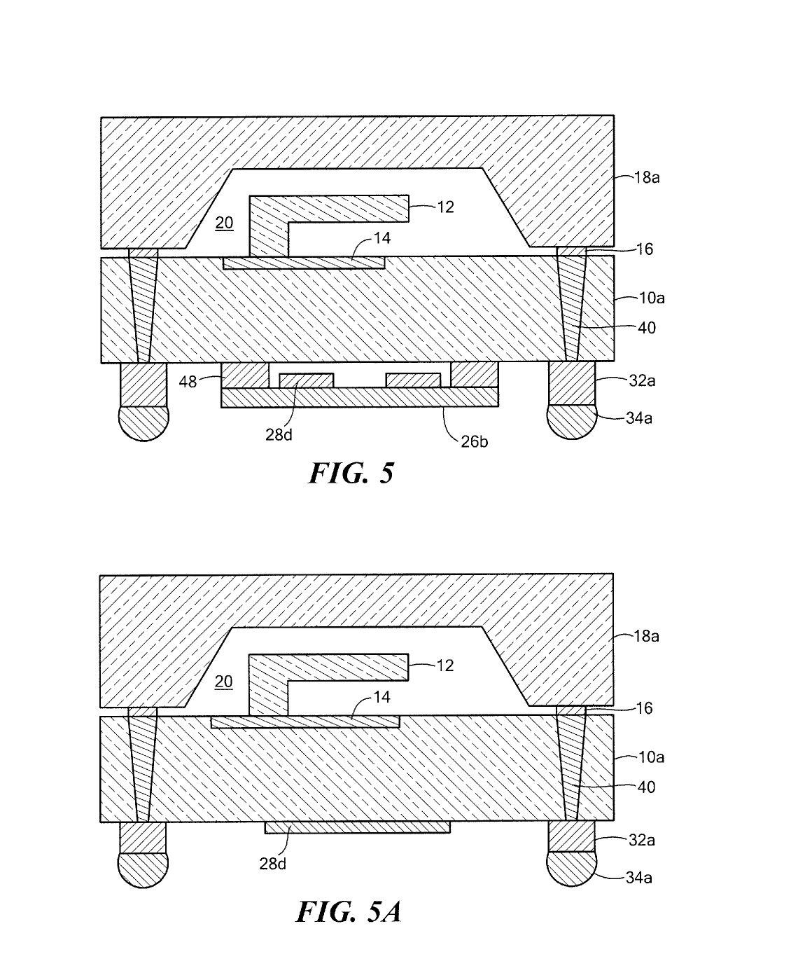

A still further embodiment is shown in FIG. 5 in which the magnetic sensor is disposed on the bottom side of the wafer 10a. The wafer 26b is mounted to the bottom surface of wafer 10a by pads 48 which are disposed inward of the pillars 32a. The magnetic sensors 28d are on the upper surface of the wafer 26b, or may be integrated in wafer 26b. This embodiment can be of smaller height than the embodiments having a third wafer as in FIG. 1 and FIG. 2.

A variation of the implementation of the embodiment of FIG. 5 is illustrated in FIG. 5A. In the embodiment of FIG. 5A the magnetic sensor 28d is fabricated on the lower surface of wafer or substrate 10a rather than being on a separate substrate as in FIG. 5. Thus in the embodiment of FIG. 5A only a single wafer or substrate is employed to contain all of the sensors and associated circuitry, and with a protective cap over the sensor structure.

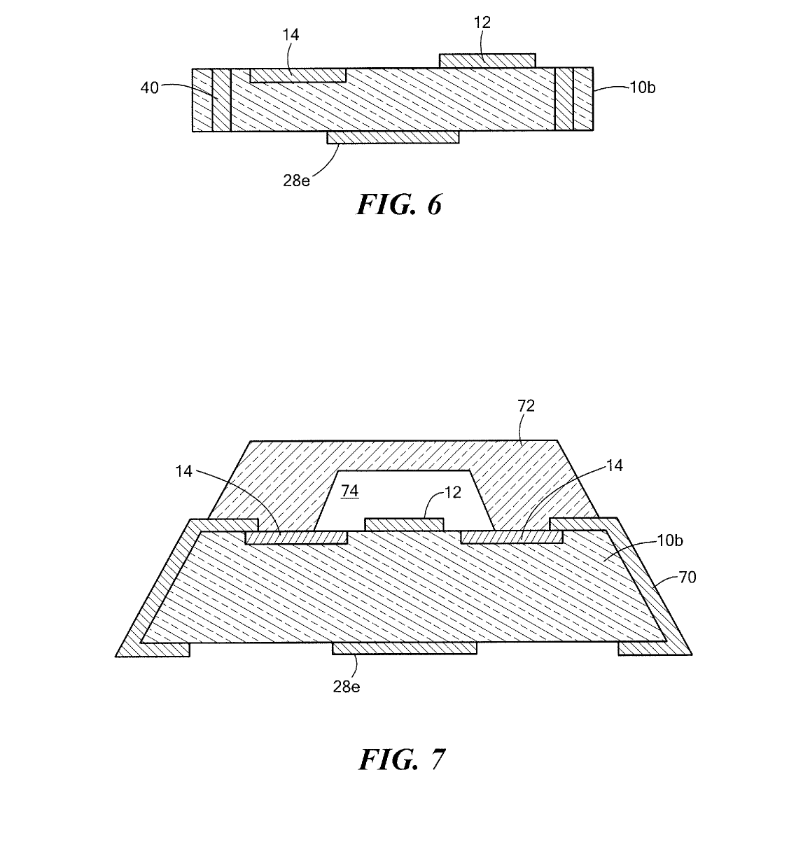

A single wafer embodiment is shown in FIG. 6 in which the MEMS structure 12 forming the accelerometer and gyroscope sensors are fabricated on the upper surface of wafer 10b. An ASIC or other circuitry 14 is fabricated on the upper surface of substrate 10b as well. A magnetic sensor 28e is fabricated on the lower surface of substrate 10b. Interconnections between the upper and lower sides of the substrate are provided in the illustrated embodiment by vias 40 as in the above described embodiments. Other interconnections between the top and bottom of the substrate can be provided by other than vias, such as chip edge interconnections. Pressure or other types of sensors can also be integrated into the wafer 10b to provide additional functionality. The vias or other interconnections are connected at one end to connection elements which are connectable to contacts on a mounting surface, as in the embodiments described above. This single wafer embodiment can be incorporated into conventional packages such as an LCC package or any other type known in the electronic packaging art.

Another single wafer embodiment is shown in FIG. 7. The MEMS structure forming the accelerometer and gyroscope sensors 12 is provided on the top of wafer 10b. The magnetic sensor 28e is provided on the bottom of wafer 10b. In this embodiment two ASIC or other circuits 14 are provided at the top of wafer 10b. Interconnections between the top and bottom of the wafer are provided by edge interconnections 70. A glass cap or cover 72 is provided on the top of wafer 10b and which has a cavity 74 enclosing the MEMS structure 12. The glass cap can be bonded to the wafer by any well known technique including glass frit, epoxy, anodic and eutectic bonding.

The MEMS sensor structures can be fabricated by known micro machining techniques using for example CMOS or silicon on insulator (SOI) techniques. In a typical embodiment the top side of the wafer contains one or more accelerometers, one or more gyroscopes and optionally pressure or other sensors. The bottom side of the wafer contains one or more magnetic sensors. Conductive interconnection of the sensors and associated electronic circuitry can be accomplished using through silicon vias, chip edge metal routing techniques or bumping to a substrate and wire bonding to the front or top side of a wafer. Standard MEMS die packaging or vacuum packaging techniques can be employed to provide a suitable environment for the MEMS mechanical structures or devices.

In the embodiments described above, an underfill material can be provided between the confronting substrates to enhance package reliability. An underfill can also be provided between the bottom substrate and a circuit board on which the package is mounted.

It is contemplated that other types of sensors can be integrated with the accelerometer, gyroscope and magnetic sensors in one or more wafers of a unitary structure. For example, pressure, acoustic, chemical and humidity sensors among others can be incorporated into the one or more wafers to provide additional functionality within the same unitary package. For some implementations, all of the orientation sensors may not be needed. Any combination of accelerometer, gyroscope, magnetic or other sensor may be provided in accordance with the invention to suit particular application requirements.

It is also contemplated that various forms of interconnection can be provided to interconnect the top and bottom surfaces of a wafer or to interconnect two or more wafers of a unitary package. For example, as noted above, interconnection can be accomplished by vias or by edge connections or wire bonding techniques. In addition, multiple wafers can be bonded together by any of the known bonding techniques, and the unitary structure composed of one or more wafers can be packaged or housed in any of the many forms of known electronic packaging.

Thus the invention is not to be limited by what has been particularly shown and described but is to embrace the spirit and full scope of the claims.

What is claimed is:

1. A unitary sensor package comprising:
a magnetic sensor, an accelerometer sensor and a gyroscope sensor incorporated into a monolithic structure composed of at least one substrate bonded together; and
at least one of the substrates having a plurality of interconnections between the sensors and connection elements on the monolithic structure which are connectable to contacts on a mounting surface.

2. The unitary sensor package of claim 1 wherein the magnetic, accelerometer and gyroscope sensors are MEMS devices.

3. The unitary sensor package of claim 1 including circuitry associated with at least one of the sensors integrated in a substrate.

4. The unitary sensor package of claim 3 wherein the accelerometer and gyroscope sensors are on one surface of a single substrate and the magnetic sensor is on the opposite surface of the single substrate.

5. The unitary sensor package of claim 4 including a cover bonded to the one surface of the single substrate and having a cavity enclosing the accelerometer and gyroscope sensors.

6. The unitary sensor package of claim 2 wherein the accelerometer and gyroscope sensors are on a first substrate and wherein the magnetic sensor is on a second substrate bonded to the first substrate;
and wherein at least one of the first and second substrates have conductive vias therethrough providing interconnection of the sensors to the connection elements.

7. The unitary sensor package of claim 6 wherein the conductive vias are through the first substrate.

8. The unitary sensor package of claim 6 wherein the conductive vias are through the first and second substrates.

9. The unitary sensor package of claim 1 wherein the connection elements include solder balls connected to conductive vias through a substrate and connectable to contacts on a mounting surface.

10. The unitary sensor package of claim 2 wherein the connection elements are on the outer surface of the first substrate.

11. The unitary sensor package of claim 2 wherein the connection elements are on the outer surface of the second substrate.

12. The unitary sensor package of claim 6 wherein the second substrate has a cavity covering the accelerometer and gyroscope sensors;
and wherein the magnetic sensor is in the cavity of the second substrate.

13. The unitary sensor package of claim 6 wherein the second substrate has a cavity covering the accelerometer and gyroscope sensors;
and wherein the magnetic sensor is on an outer surface of the second substrate.

14. The unitary sensor package of claim 1 including:
a third substrate bonded to one of the first and second substrates;
and wherein the magnetic sensor is on the third substrate and connected to conductive vias through the first or second substrate to which the third substrate is bonded.

15. The unitary sensor package of claim 12 wherein the second substrate has a cavity therein which encloses the accelerometer and gyroscope sensors;
the cavity having at least one sloping wall on which the magnetic sensor is disposed.

16. The unitary sensor package of claim 1 wherein the second wafer has a first cavity therein which encloses the accelerometer and gyroscope sensors and which has a second cavity therein having at least one sloping wall on which the magnetic sensor is disposed.

17. The unitary sensor package of claim 1 wherein the magnetic sensor is disposed on an outer surface of the first substrate.

18. The unitary sensor package of claim 17 wherein the magnetic sensor on the outer surface of the first substrate is covered by an encapsulation layer.

19. The unitary sensor package of claim 1 including an additional sensor provided on the at least one substrate and operative to sense a property other than orientation.

20. The unitary sensor package of claim 19 wherein the additional sensor is a pressure sensor.

21. A unitary sensor package comprising:
at least one orientation sensor selected from the group consisting of a magnetic sensor, an accelerometer sensor and a gyroscope sensor incorporated into a monolithic structure composed of at least one substrate; and
at least one of the substrates having a plurality of interconnections between the sensors and connection elements on the monolithic structure which are connectable to contacts on a mounting surface.

22. The unitary sensor package of claim 21 including an additional sensor provided on the at least one substrate and operative to sense a property other than orientation.

23. A unitary sensor package comprising:
a first substrate containing an integrated circuit, a MEMS three axis accelerometer and a MEMS three axis gyroscope and having a first bonding area about the periphery of one surface of the first substrate;
a second substrate disposed on the first substrate and having a second bonding area about the periphery of the second substrate bonded to the first bonding area of the first substrate, the second substrate having a plurality of conductive vias through the second substrate and being electrically connected to contact pads on respective ends of the vias; and
a third substrate having a magnetic sensor and disposed on the second substrate and having a peripheral bonding area bonded to a bonding area of the confronting surface of the second substrate, the third substrate having a plurality of conductive vias through the third substrate and interconnecting contact pads at the end of the vias confronting the second substrate and connection elements on the outer surface of the third substrate.

24. A unitary sensor package comprising:
a first substrate containing an integrated circuit, a MEMS accelerometer and a MEMS gyroscope and having a first bonding area about the periphery of an inner surface of the first substrate and having a plurality of conductive vias through the first substrate between the inner surface and an outer surface of the first substrate;
a plurality of connection elements on the outer surface of the first substrate connected to the conductive vias through the first substrate;
a second substrate disposed on the first substrate and having a second bonding area about the periphery of the second substrate bonded to the first bonding area of the first substrate, the second substrate having a plurality of conductive vias through the second substrate and being electrically connected to the conductive vias of the first substrate; and
a third substrate having a magnetic sensor and disposed on the second substrate and having a peripheral bonding area bonded to a bonding area of the confronting surface of the second substrate.

25. A unitary sensor package comprising:
a first substrate containing an integrated circuit, a MEMS accelerometer and a MEMS 3 axis gyroscope and having a first bonding area about the periphery of one surface of the first substrate and a plurality of conductive vias through the first substrate extending between the one surface and an opposite surface of the first substrate, and having a plurality of connection elements on the opposite surface of the first substrate connected to the conductive vias through the first substrate; and
a second substrate disposed on the first substrate and having a second bonding area about the periphery of the second substrate bonded to the first bonding area of the first substrate, the second substrate having a magnetic sensor and having contact pads connected to the vias through the first substrate and interconnecting the magnetic sensor.
